(19) United States
(12) Patent Application Publication
(10) Pub. No.: US 2003/0041697 A1
(43) Pub. Date: Mar. 6, 2003

(54) Ratchet wrench

(76) Inventor: Chih-Ching Hsien, Taichung (TW)

Correspondence Address: Chih-Ching Hsien, 235 Chung-Ho, Box 8-24, Taipei, TW

(21) Appl. No.: 10/209,061

(22) Filed: Jul. 29, 2002

(30) Foreign Application Priority Data
Sep. 4, 2001 (TW) 090215381

(51) Int. Cl. B25B 13/46

(52) U.S. Cl. 81/60

(57) ABSTRACT

A ratchet wrench includes a wrench body having a box at one end, a ratchet wheel, an arched stop block, and a thumbscrew respectively mounted in the box of the wrench body, the arched stop block has one end pivoted to the wrench body, the other end supported on a spring member in the wrench body, and an opening in the middle, the thumbscrew is mounted in the opening of the arched stop block and meshed with the sloping teeth of the ratchet wheel to limit the direction of rotation of the ratchet wheel and for rotating by the thumb to rotate the ratchet wheel in the box.

### BACKGROUND OF THE INVENTION

The present invention relates to wrenches, and more specifically, to a simple structure of ratchet wrench, which is easy to assemble.

FIGS. 1 and 2 show a ratchet wrench according to the prior art. This structure of ratchet wrench comprises a wrench body covered with top and bottom cover plates to hold a ratchet wheel, a work member in the ratchet wheel, a spring member, a slide supported on the spring member, and a threaded control member mounted in the slide and meshed with the ratchet wheel to control the direction of rotation of the ratchet wheel. Because the slide is supported on the spring member, the threaded control member and the slide tend to be forced backwards when driving the ratchet wheel and the work member to rotate the workpiece. Further, the user cannot rotate the ratchet wheel with the fingers through a small angle without turning the wrench body when working in a narrow space. FIG. 3 shows another structure of ratchet wrench according to the prior art. This design of ratchet wrench is comprised of a wrench body, a ratchet wheel, a worm, a socket connector, a stop block, and a direction switch. The worm is mounted in a recessed hole in the wrench body and meshed with the ratchet wheel, and can be driven with the thumb to rotate the ratchet wheel pitch by pitch. This design of ratchet wrench is functional, however it is comprised of a number of parts. The complicated structure greatly increases the manufacturing cost of this design of ratchet wrench..

### SUMMARY OF THE INVENTION

The present invention has been accomplished to provide a ratchet wrench, which eliminates the aforesaid drawbacks. It is one object of the present invention to provide a ratchet wrench, which provides a fine adjustment function. It is another object of the present invention to provide a ratchet wrench, which has a simple structure. It is still another object of the present invention, which can be driven to fasten tight the workpiece without turning the wrench body. To achieve these and other objects of the present invention, the ratchet wrench comprises a wrench body, the wrench body comprising a box at one end thereof, the box comprising a circular receiving open chamber, and a recess in communication with the circular receiving open chamber at one side; an annular ratchet wheel mounted in the circular receiving open chamber, the ratchet wheel comprising a serrated center coupling hole adapted to hold a socket, bolt, or nut, and a series of sloping teeth arranged around the periphery thereof and sloping in one direction; and a stop mechanism mounted in the recess of the wrench body and meshed with the sloping teeth of the annular ratchet wheel to control the direction of rotation of the annular ratchet wheel in the box. The stop mechanism comprises an arched stop block, the arched stop block having a first end pivoted to the wrench body near one side of the recess, a second end, an opening between the first end and the second end, and a back notch in the second end; a spring member adapted to force the second end of the arched stop block toward the annular ratchet wheel, the spring member having a first end engaged into the back notch of the arched stop block and a second end connected to a vertical peripheral wall of the recess; and a thumbscrew mounted in the opening of the arched stop block and meshed with the sloping teeth of the annular ratchet wheel for rotating by the thumb to rotate the annular ratchet wheel in the box.

### BRIEF DESCRIPTION OF THE DRAWINGS

FIG. 1 is an exploded view of a ratchet wrench according to the prior art.

FIG. 2 is a sectional assembly view in an enlarged scale of the prior art ratchet wrench shown in FIG. 1.

FIG. 3 is a sectional assembly view of another structure of ratchet wrench according to the prior art.

FIG. 4 is an elevational view of a part of a ratchet wrench according to the present invention.

FIG. 5 is an exploded view of the ratchet wrench shown in FIG. 4.

FIG. 6 is a top view in section of the ratchet wrench shown in FIG. 4.

FIG. 7 is an elevational view of a part of an alternate form of the ratchet wrench according to the present invention.

FIG. 8 is an exploded view of the ratchet wrench shown in FIG. 7.

FIG. 9 is a top view in section of the ratchet wrench shown in FIG. 7.

FIG. 10 is a top view in section of a part of another alternate form of the ratchet wrench according to the present invention.

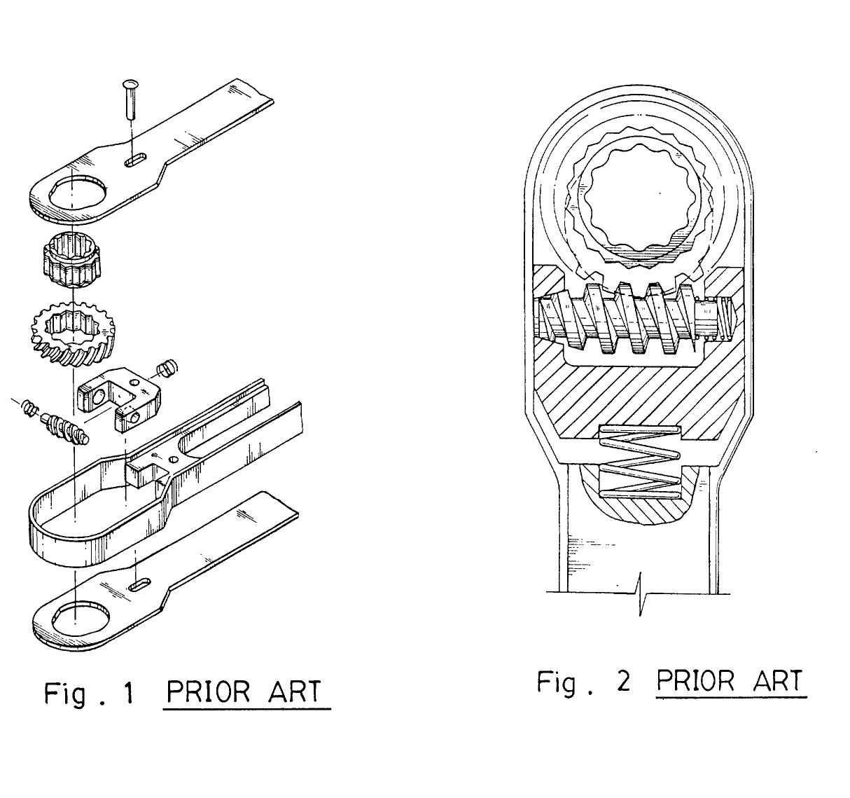

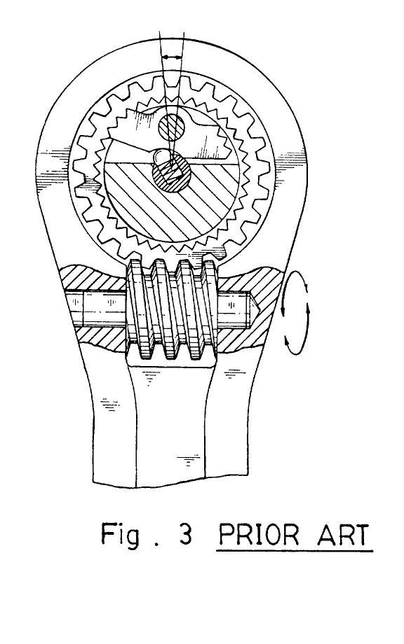

### DETAILED DESCRIPTION OF THE PREFERRED EMBODIMENT

Referring to FIGS. from 4 through 6, a ratchet wrench is shown comprised of a wrench body 10, an annular ratchet wheel 20, a stop block 30, a thumbscrew 40, and a cover plate 50.

The wrench body 10 comprises a handle 12 and a box 11 integral with one end of the handle 12. The box 11 comprises a circular receiving open chamber 13, an arched recess 14 in communication with the circular receiving open chamber 13 at one side, and a pin hole 15 near one lateral side of the arched recess 14.

The annular ratchet wheel 20 is mounted in the circular receiving open chamber 13 of the box 11, comprising a serrated center coupling hole 21 adapted to hold a socket, bolt, or nut, and a series of sloping teeth 22 arranged around the periphery thereof and sloping in one direction.

The stop block 30 is an arched block fitting the arched recess 14, having a vertical pivot hole 31 disposed at one end and pivotally connected to the pin hole 15 inside the box 11 of the wrench body 10 by a pivot pin 61, an opening 32 on he middle, and a backward notch 33 disposed at the other end. A spring member 62 is provided having a front end engaged into the backward notch 33 of the stop block 30 and a rear end connected to the vertical peripheral wall of the recess 14.

The thumbscrew 40 is supported in the opening 32 of the arched block 30, having a spiral thread 41 meshed with the sloping teeth 22 of the annular ratchet wheel 20. Further the thumbscrew 40 has one end stopped at one lateral side of the opening 32, and the other end supported on a spring member 63 in the other lateral side of the opening 32. The spring member 63 holds the thumbscrew 40 stably in the opening 32, keeping the spiral thread 41 of the thumbscrew 40 in engagement with the sloping teeth 22 of the annular ratchet wheel 20 positively.

The cover plate 50 is fastened to the box 11 of the wrench body 10 to hold the annular ratchet wheel 20, the arched block 30, the thumbscrew 410, and the springs 62 and 63 in place, having a circular center hole 51 corresponding to the serrated center coupling hole 21 of the annular ratchet wheel 20, and a finger hole 52 corresponding to the spiral thread 41 of the thumbscrew 40.

When in use, the serrated center coupling hole 21 of the annular ratchet wheel 20 is attached to the workpiece, and then the handle 12 is turned with the hand to rotate the workpiece. When turning the handle 12 in one direction, the annular ratchet wheel 20 is force to rotate the workpiece. On the contrary, when turning the handle 12 in the reversed direction, the arched stop block 30 is moved over the sloping teeth 22 of the annular ratchet wheel 20, i.e., the ratchet wrench runs idle. Further, the user can rotate the thumbscrew 40 with the thumb to further rotate the annular ratchet wheel 20 and the workpiece.

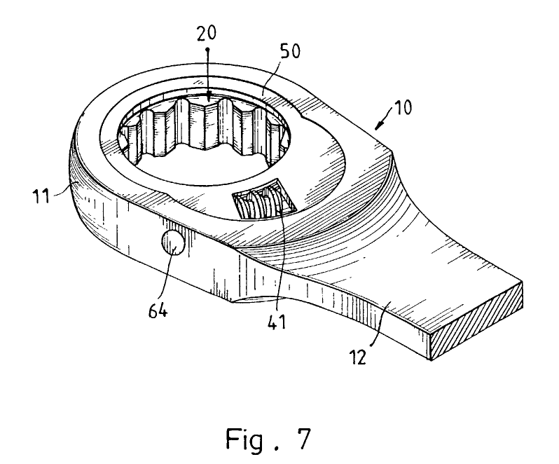

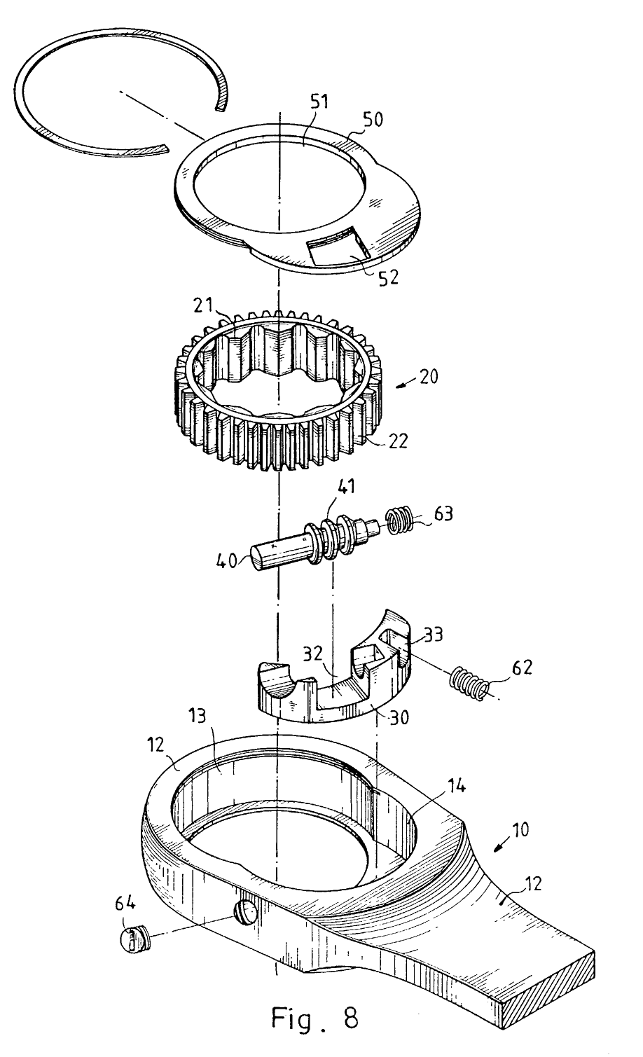

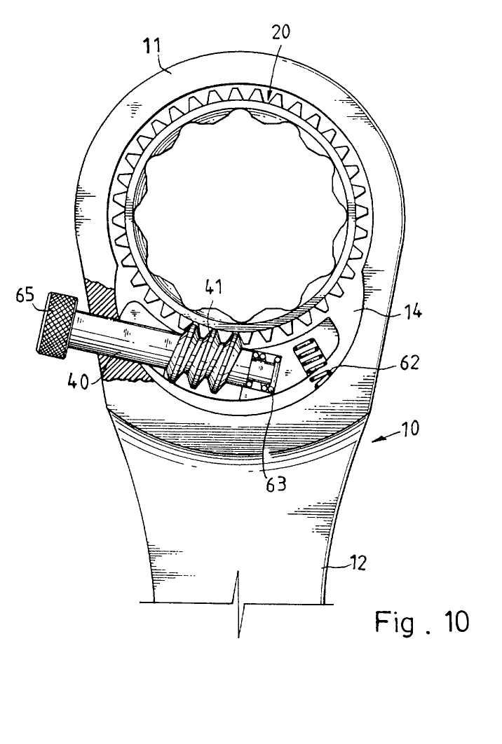

FIGS. 7˜10 show a ratchet wrench according to a second embodiment of the present invention. According to this embodiment, the thumbscrew 40 has one end extended out of the box 11 (through a transverse through hole in the peripheral wall of the box 11) and fixedly mounted with a cap 64 or knob 65. Through the cap 64 or knob 65, the thumbscrew 40 can easily be rotated with the fingers or a spanner.

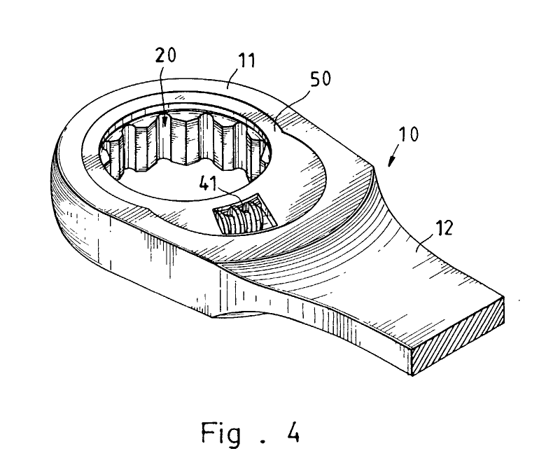

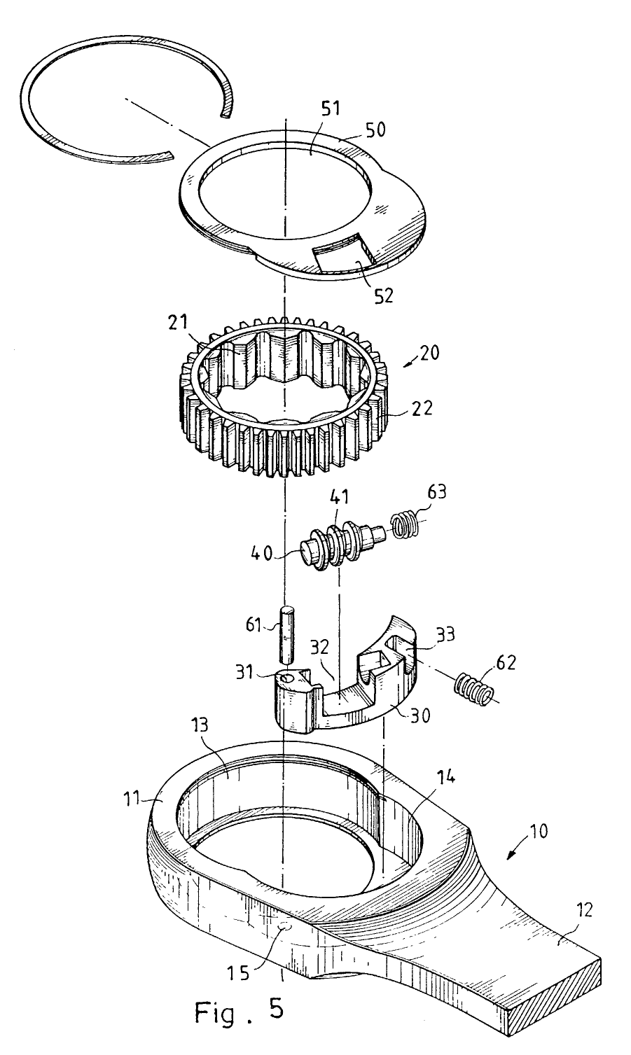

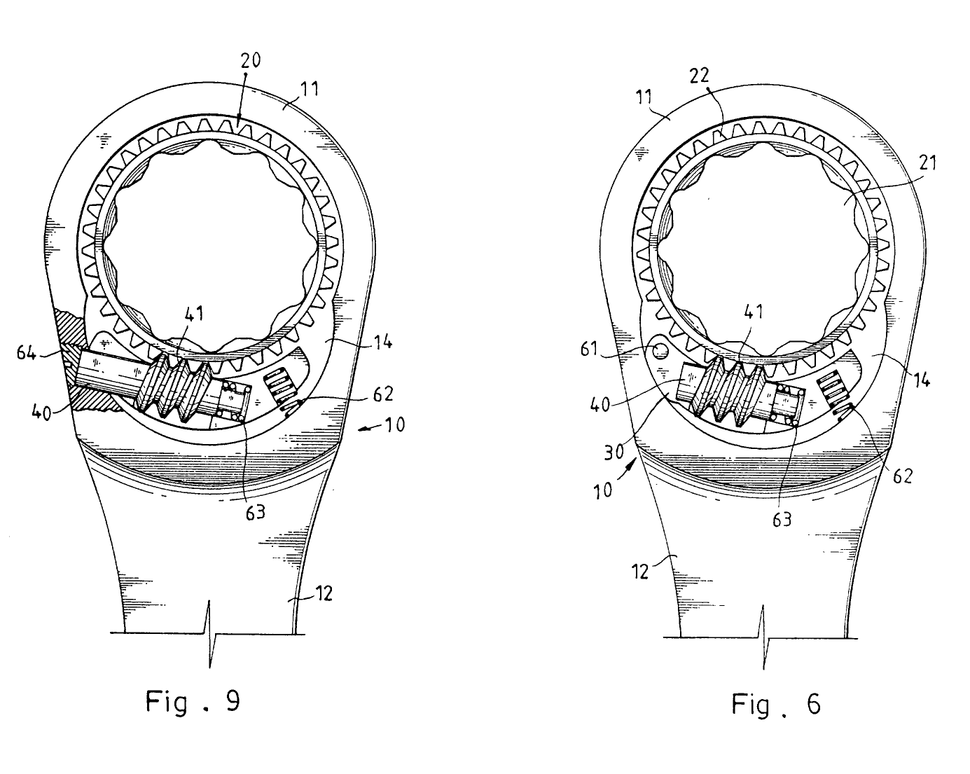

A prototype of ratchet wrench has been constructed with the features of FIGS. 4˜10. The ratchet wrench functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A ratchet wrench comprising:
a wrench body, the wrench body comprising a box at one end thereof, the box comprising a circular receiving open chamber, and a recess in communication with said circular receiving open chamber at one side;
an annular ratchet wheel mounted in said circular receiving open chamber, said ratchet wheel comprising a serrated center coupling hole adapted to hold a socket, bolt, or nut, and a series of sloping teeth arranged around the periphery thereof and sloping in one direction; and
a stop mechanism mounted in said recess of said wrench body and meshed with the sloping teeth of said annular ratchet wheel to control the direction of rotation of said annular ratchet wheel in said box;
wherein said stop mechanism comprises:
an arched stop block, said arched stop block having a first end pivoted to said wrench body near one side of said recess, a second end, an opening between said first end and said second end, and a back notch in said second end;
a spring member adapted to force the second end of said arched stop block toward said annular ratchet wheel, said spring member having a first end engaged into said back notch of said arched stop block and a second end connected to a vertical peripheral wall of said recess; and
a thumbscrew mounted in said opening of said arched stop block and meshed with the sloping teeth of said annular ratchet wheel for rotating by the thumb to rotate said annular ratchet wheel in said box.

2. The ratchet wrench as claimed in claim 1 wherein said stop mechanism further comprises a second spring member mounted in one side of said opening of said arched stop block and supporting one end of said thumbscrew in said opening of said arched stop block.

3. The ratchet wrench as claimed in claim 1 wherein said thumbscrew has one end extended out of said arched stop block and said box of said wrench body and fixedly mounted with knob for the holding of the fingers or a tool to rotate said thumbscrew.
